(19) United States
(12) Patent Application Publication
(10) Pub. No.: US 2019/0327520 A1
(43) Pub. Date: Oct. 24, 2019

(54) Set-Top Box with Enhanced Content and System and Method for Use of Same

(71) Applicant: Enseo, Inc., Richardson, TX (US)

(72) Inventors: Vanessa Ogle, Fairview, TX (US); William C. Fang, Plano, TX (US)

(21) Appl. No.: 16/390,560

(22) Filed: Apr. 22, 2019

Related U.S. Application Data
(60) Provisional application No. 62/660,470, filed on Apr. 20, 2018.

(51) Int. Cl. H04N 21/4363; H04N 21/61; H04N 21/214

(52) U.S. Cl. CPC H04N 21/43637; H04N 21/2143; H04N 21/6131; H04N 21/6125

(57) ABSTRACT

A set-top box with enhanced content and system and method for use of the same are disclosed. In one embodiment of the set-top box, at least two wireless transceivers are located within a housing, which also interconnectively includes a signal input, a signal output, a processor, and memory. The set-top box provides a fully tuned signal including general content via the signal output to a display or a television, for example. The set-top box may also identify a proximate wireless-enabled interactive programmable device and responsive to identifying the proximate wireless-enabled interactive programmable device, send and receive wireless signals utilizing a fifth generation wireless signal standard.

### PRIORITY STATEMENT & CROSS-REFERENCE TO RELATED APPLICATION

This application claims priority from co-pending U.S. Patent Application Ser. No. 62/660,470 entitled “Set-Top Box with Enhanced Content and System and Method for Use of Same” filed on Apr. 20, 2018, in the names of William C. Fang and Vanessa Ogle; which is hereby incorporated by reference for all purposes.

### TECHNICAL FIELD OF THE INVENTION

This invention relates, in general, to set-top boxes and, in particular, to set-top boxes with enhanced content and systems and methods for use of the same that address and improve the experience provided to individuals in physical proximity to the set-top boxes.

### BACKGROUND OF THE INVENTION

Without limiting the scope of the present invention, the background will be described in relation to televisions in the hospitality lodging industry, as an example. To many individuals, a stay in a hospitality establishment is more than just lodging, rather it is a second home or an adventure to experience new possibilities and discoveries. Consumers are demanding enhanced content in an easy-to-use platform within rooms serviced by the hospitality lodging industry. As a result of such consumer preferences, the quality of content and ease-of-use are frequent differentiators in determining the experience of guests staying in hospitality lodging establishments. Accordingly, there is a need for improved systems and methods for providing enhanced content in an easy-to-use platform in the hospitality lodging industry.

### SUMMARY OF THE INVENTION

It would be advantageous to achieve a set-top box that would improve upon existing limitations in functionality. It would also be desirable to enable a computer-based electronics and software solution that would provide enhanced content in an easy-to-use platform in the hospitality lodging industry or in another environment. To better address one or more of these concerns, a set-top box with enhanced content and system and method for use of the same are disclosed. In one embodiment of the set-top box, at least two wireless transceivers are located within a housing, which also interconnectively includes a signal input, a signal output, a processor, and memory.

The set-top box provides a fully tuned signal including general content via the television output to a display or a television, for example. The set-top box may also identify a proximate wireless-enabled interactive programmable device and responsive to identifying the proximate wireless-enabled interactive programmable device, send and receive wireless signals utilizing a fifth generation wireless signal standard via one of the wireless transceivers. These and other aspects of the invention will be apparent from and elucidated with reference to the embodiments described hereinafter.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a schematic diagram depicting one embodiment of a system for providing a set-top box having enhanced content thereon according to the teachings presented herein;

FIG. 2A is a schematic diagram depicting one embodiment of the system of FIG. 1 within an on-property deployment;

FIG. 2B is a schematic diagram depicting one embodiment of the system of FIG. 1 within a cloud-computing deployment;

FIG. 3A is a wall-facing exterior elevation view of one embodiment of the set-top box depicted in FIG. 1 in further detail;

FIG. 3B is a television-facing exterior elevation view of the set-top box depicted in FIG. 1;

FIG. 3C is a front perspective view of a dongle depicted in FIG. 1 in further detail;

FIG. 4 is a functional block diagram depicting one embodiment of the set-top box presented in FIGS. 3A and 3B;

FIG. 5 is a signalization timing depicting one embodiment of an operational process furnishing enhanced content according to the teachings presented herein; and

FIG. 6 is a flow chart depicting one embodiment of a method for providing a set-top box having enhanced content thereon according to the teachings presented herein.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention, and do not delimit the scope of the present invention.

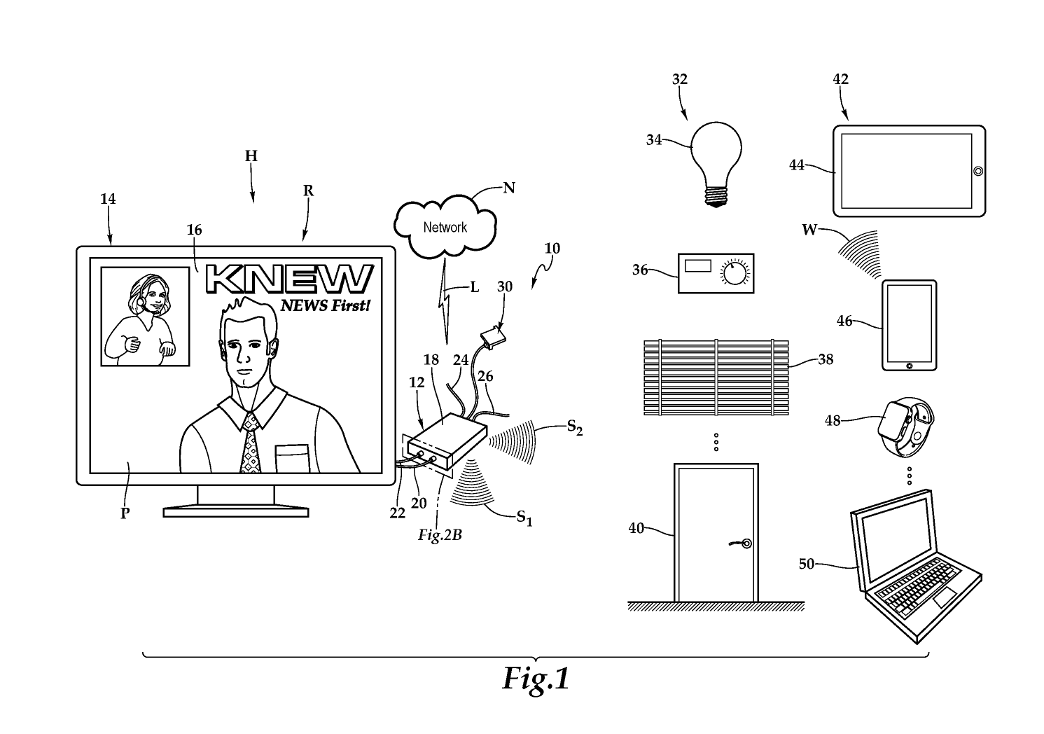

Referring initially to FIG. 1, therein is depicted one embodiment of a system 10 utilizing set-top box 12 with enhanced content capabilities being employed within a hospitality lodging establishment. The hospitality lodging establishment or, more generally, hospitality property, may be a furnished multi-family residence, dormitory, lodging establishment, hotel, hospital, or other multi-unit environment. As shown, by way of example and not by way of limitation, the hospitality environment is depicted as a hotel H having various rooms and spaces. The set-top box 12 is communicatively disposed with various amenities associated with the hospitality environment, including a display 14. Set-top boxes, like the set-top box 12, may be deployed throughout the rooms and spaces of the hotel H.

As shown, in one embodiment, within a hotel room R, for example, the system 10 includes the set-top box 12 and the display 14, which is illustrated as a television having a screen 16. It should be appreciated however, that the display 14 may also be any electronic visual display device, for example. The set-top box 12 includes a housing having a connection, which is depicted as an HDMI connection 20, connecting the set-top box 12 to the display 14. Other connections include a power cable 22 coupling the set-top box 12 to a power source, a coaxial cable 24 coupling the set-top box 12 to an external cable source, and a category five (Cat 5) cable 26 coupling the set-top box 12 to an external pay-per-view source at a hotel or other lodging establishment, for example. As shown, the set-top box 12 may include a dongle 30 providing particular technology and functionality extensions thereto. That is, the set-top box 12 may be set-top box-dongle combination in one embodiment. More generally, it should be appreciated that the cabling connected to the set-top box 12 will depend on the environment and application, and the cabling connections presented in FIG. 1 are depicted for illustrative purposes. Further, it should be appreciated that the positioning of the set-top box 12 will vary depending on environment and application and, with certain functionality, the set-top box 12 may be placed more discretely behind the display 14.

As shown, the set-top box 12 may include an interactive program guide configured to provide continuously updated interactively navigable menus displaying broadcast scheduling for current and upcoming programming relative to an external source. The interactive program guide may also be configured to provide interactively navigable menus displaying on-site hospitality information. In the illustrated embodiment, the set-top box 12 is receiving a source signal from the external source via the coaxial cable 24 and forwarding a fully tuned signal to the display 14, including the program P, on the HDMI connection 20.

As mentioned, the set-top box also wirelessly communicates with various amenities 32 within an environment of the room R. As shown, the amenities may include lighting 34, a thermostat 36, window shades 38, and a door indication for “Please Do Not Disturb.” A proximate wireless-enabled interactive programmable device 42 may be a device, including handheld devices, that may be supplied or carried by an individual or, in an hospitality establishment embodiment, the guest and may be selected from a range of existing devices, such as, for example personal computers, laptops, tablet computers, smart phones, smart speakers, and smart watches, for example. As shown in the illustrated embodiment, a tablet computer 44, a smart phone 46, a smart watch 48, and a laptop 50 are depicted.

In one implementation, advertising broadcast data originating from the set-top box 12 or the proximate wireless-enabled interactive programmable device 42 may be utilized to identify the proximate wireless-enabled interactive programmable device 42. Further, in another implementation, an application installed from a server enables the set-top box 12 and the proximate wireless-enabled interactive programmable device 42 to be wirelessly paired. In another embodiment, a challenge-response is utilized to wirelessly pair the set-top box 12 and the proximate wireless-enabled interactive programmable device 42. Upon identifying the proximate wireless-enabled interactive programmable device 42, the set-top box 12 sends and receives wireless data with the proximate wireless-enabled interactive device 42 utilizing a fifth generation (5G) wireless signal standard. As shown, the set-top box 12 sends a wireless signal S₁ and a 5G wireless signal S2. The smart phone 4G is receiving the 5G wireless signal S2 and transmits 5G wireless signal W in response thereto. The fifth generation wireless signal standard may include millimeter wave band technology, millimeter wave band technology from 26 GHz to 60 GHz. In this manner, the set-top box 12 provides an access point having a transmission link L to a network N. The network N may be a cellular network, a fifth generation cellular network, or the Internet, for example.

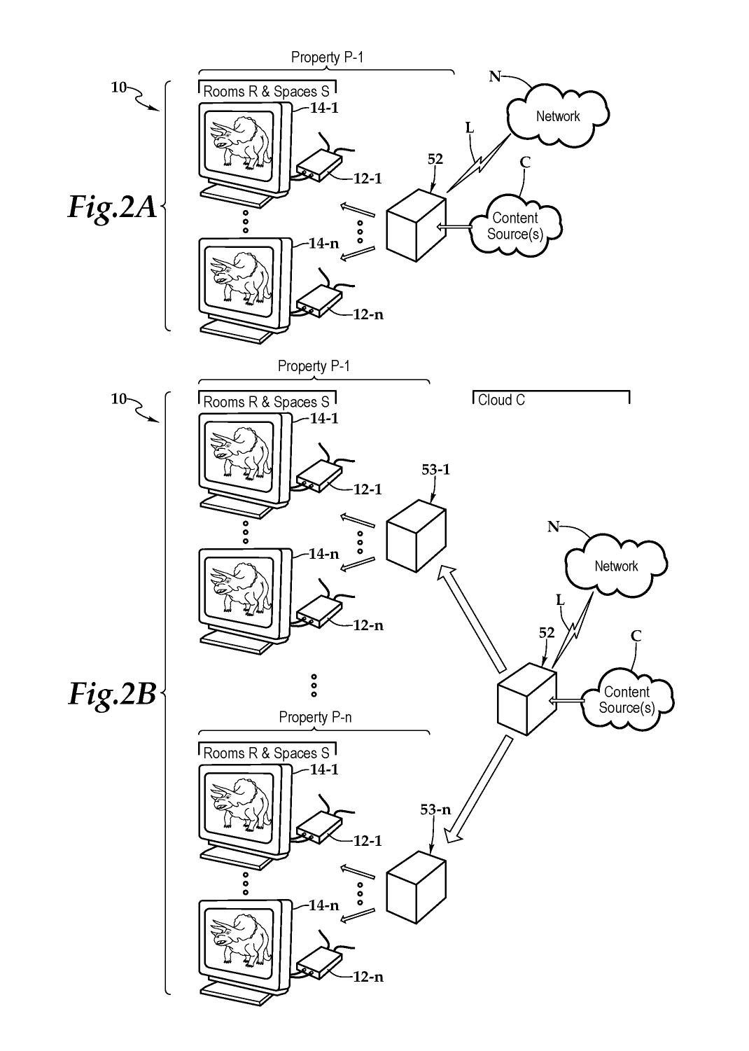

It should be appreciated that a server 52 supporting the set-top box may be located on a single property to serve one or more set-top boxes thereon. Further, it should be appreciated that the server 52 may be remotely located to serve multiple properties having multiple televisions. Referring now to FIG. 2A, the system 10 may be deployed such that the server 52 is co-located on the property P-1 with the displays 14-1 . . . 14-n and the corresponding set-top boxes 12-1 . . . 12-n, with, in one embodiment, content sources C configured to provide sources of content and the network N. As previously alluded, the server 52 may provide updates for the interactive program guide.

Referring to FIG. 2B, the system 10 may be deployed such that the server 52 is located remotely within cloud C relative to displays 14-1 . . . 14-n, which are located at properties P-1 through P-n. In particular, the sever 52, which receives content from content sources C and the 5G services from network N, may be located remotely relative to the displays 14-1 . . . 14-n and any set-top boxes 12-1 . . . 12-n such that a property headend 53-1 . . . 53-n is interposed between the server 52 and the displays 14-1 . . . 14-n. As shown, in this implementation, the property headend 53-1 . . . 53-n is co-located with the televisions 14-1 . . . 14-n at a respective property, P-1 through P-n. The server 52 may provide updates for the interactive program guide.

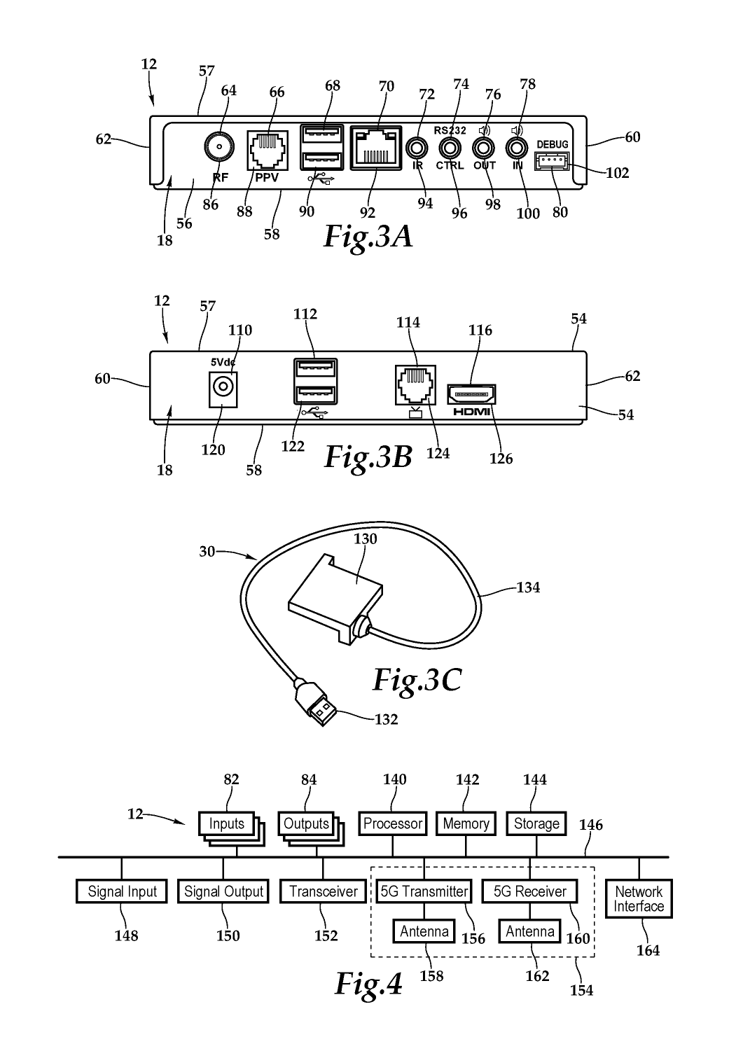

Referring to FIG. 3A, FIG. 3B, FIG. 3C, and FIG. 4, as used herein, set-top boxes, back boxes and set-top/back boxes may be discussed as set-top boxes. By way of example, the set-top box 12 may be a set-top unit that is an information appliance device that generally contains set-top box functionality including having a television-tuner input and displays output through a connection to a display or television set and an external source of signal, turning by way of tuning the source signal into content in a form that can then be displayed on the television screen or other display device. Such set-top boxes are used in cable television, satellite television, and over-the-air television systems, for example. As mentioned, in this embodiment, the set-top box 12 may include an interactive program guide configured to provide continuously updated interactively navigable menus displaying broadcast scheduling for current and upcoming programming relative to the external source. The interactive program guide may also be configured to provide interactively navigable menus displaying on-site hospitality information.

The set-top box 12 includes a housing 18 having a rear wall 54, front wall 56, top wall 57, bottom base 58, and two sidewalls 60, 62. It should be appreciated that front wall, rear wall, and side wall are relative terms used for descriptive purposes and the orientation and the nomenclature of the walls may vary depending on application. The front wall 56 includes various ports, ports 64, 66, 68, 70, 72, 74, 76, 78, and 80 that provide interfaces for various interfaces, including inputs and outputs. In one implementation, as illustrated, the ports 64 through 80 include inputs 82 and outputs 84 and, more particularly, an RF input 86, a RJ-45 input 88, universal serial bus (USB) input/outputs 90, an Ethernet category 5 (Cat 5) coupling 92, an internal reset 94, an RS232 control 96, an audio out 98, an audio in 100, and a debug/maintenance port 102. The rear wall 54 also includes various inputs 82 and outputs 84. More particularly, ports 110, 112, 114, and 116 include a 5V dc power connection 120, USB inputs/outputs 122, an RJ-45 coupling 124, and an HDMI port 126. It should be appreciated that the configuration of ports may vary with the set-top box depending on application and context. As previously alluded to, the housing 18 may include a housing-dongle combination including, with respect to the dongle 30, a unit 130 having a cable 134 with a set-top box connector 132 for selectively coupling with the set-top box 12.

Within the housing 18, a processor 140, memory 142, storage 144, the inputs 82, and the outputs 84 are interconnected by a bus architecture 146 within a mounting architecture. It should be understood that the processor 140, memory 142, storage 144, the inputs 82, and the outputs 84 may be entirely contained within the housing 18 or the housing-dongle combination. The processor 140 may process instructions for execution within the computing device, including instructions stored in the memory 142 or in storage 144. The memory 142 stores information within the computing device. In one implementation, the memory 142 is a volatile memory unit or units. In another implementation, the memory 142 is a non-volatile memory unit or units. Storage 144 provides capacity that is capable of providing mass storage for the set-top box 12. Various inputs 82 and outputs 84 provide connections to and from the computing device, wherein the inputs 82 are the signals or data received by the set-top box 12, and the outputs 84 are the signals or data sent from the set-top box 12.

A television content signal input 148 and a television content signal output 150 are also secured in the housing 18 in order to receive content from a source in the hospitality property and forward the content, including external content such as cable and satellite and pay-per-view (PPV) programming, to the television located within the hotel room.

A transceiver 152 is associated with the set-top box 12 and communicatively disposed with the bus 146. As shown the transceiver 152 may be internal, external, or a combination thereof to the housing. Further, the transceiver 152 may be a transmitter/receiver, receiver, or an antenna for example. Communication between various amenities in the hotel room and the set-top box 12 may be enabled by a variety of wireless methodologies employed by the transceiver 152, including 802.11, 3G, 4G, Edge, Wi-Fi, ZigBee, near field communications (NFC), Bluetooth low energy and Bluetooth, for example. Also, infrared (IR) may be utilized.

A transceiver 154 is also associated with the set-top box 12 and communicatively disposed with the bus 146. As shown the transceiver 154 may be internal, external, or a combination thereof to the housing. Further, the transceiver 154 may be a transmitter/receiver, receiver, or an antenna for example. In the illustrated embodiment, the transceiver 154 includes a 5G transmitter 156 coupled to an antenna 158. Also, a 5G receiver 160 is coupled to an antenna 162. The antennas 158, 162 may be multiple input multiple output (MIMO) antennas, low-band 5G antennas, mid-band 5G antennas, or 5G radio components, for example. A network interface 164 is coupled to the bus 146 to provide a device component that connects to the network.

The memory 142 and storage 144 are accessible to the processor 140 and include processor-executable instructions that, when executed, cause the processor 140 to execute a series of operations. The processor-executable instructions forward the fully tuned signal to the display and, as mentioned, the fully tuned signal including general content. The processor-executable instructions also specify a search operation to identify the proximate wireless-enabled interactive programmable device by receiving advertising broadcast data from the proximate wireless-enabled interactive programmable device 42 via the wireless transceiver using, for example, a Bluetooth low energy standard, wherein the search operation utilizes the wireless transceiver to wirelessly identify the proximate wireless-enabled interactive programmable device 42. Alternatively, the processor-executable instructions, when executed, cause the processor 140 to specify a search operation to identify the proximate wireless-enabled interactive programmable device 42 by transmitting advertising broadcast data via the wireless transceiver using, for example, a Bluetooth low energy standard, wherein the search operation utilizes the wireless transceiver to wirelessly identify the proximate wireless-enabled interactive programmable device 42. Responsive to identifying the proximate wireless-enabled interactive programmable device 42, processor-executable instructions cause the processor 140 to utilize the transceiver 154 to send and receive wireless data, which is based on the fifth generation wireless signal standard. The processor-executable instructions also cause the processor 140 to utilize the network interface to provide a transmission link for the wireless data with the network.

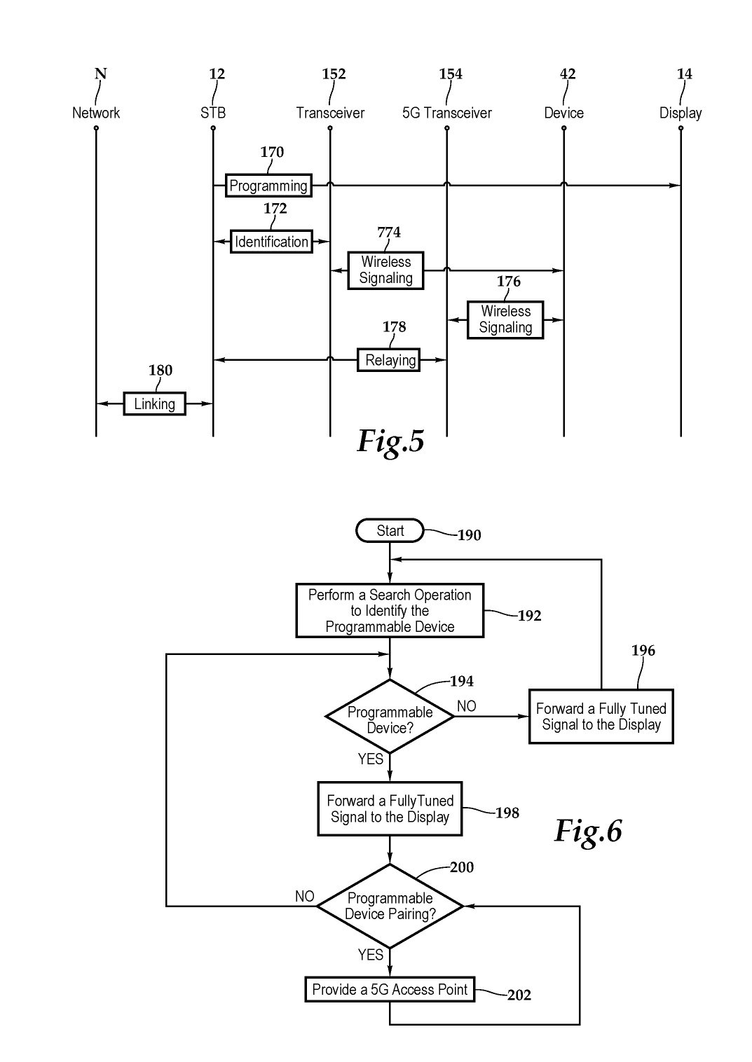

Referring now to FIG. 5, wherein signalization timing between the set-top box 12, the wireless transceiver 152, the wireless transceiver 154, the display 14, the network N, and the proximate wireless-enabled programmable interactive device 42 is depicted. At signaling block 170, a fully tuned audiovisual signal containing programming is forwarded from the set-top box 12 to the display 14. At signaling blocks 172 and 174, a proximate wireless enabled interactive programmable device 42 establishes a pairing with the set-top box 12. As a result, at signaling blocks 176, 178, 180, the set-top box 12 acts as a 5G access point for the proximate wireless-enabled programmable interactive device 42.

FIG. 6 depicts one embodiment of a method for providing enhanced content, according to the teachings presented herein. At block 190, the proximate wireless-enabled interactive programmable device 42 is registered. In one implementation, this may involve using an existing application on the proximate wireless-enabled interactive programmable device 42, such as a browser, or downloading a new application. As mentioned, the registration may occur at the time of room reservation, event reservation, room check-in or event check-in, for example with an individual's proximate wireless-enabled interactive programmable device being associated with the individual at the same time, for example.

At block 192, a search, which may be active or passive, is performed by the set-top box to identify a physically proximate programmable device within the multi-room environment. At decision block 194, if a programmable device is not found, then at block 196, a fully tuned signal is provided to the display, which may be a television. The methodology then returns to block 192. Returning to decision block 194, if a programmable device is located, then at block 198, a fully tuned signal is forwarded to the display.

At decision block 200, if the proximate wireless-enabled interactive programmable device doesn't want a pairing, then the methodology returns to decision block 194. On the other hand, if the proximate wireless-enabled interactive programmable device initiates a pairing, by way of an application or pre-setting, for example, then the methodology advances to block 202. At block 202, the set-top box provides a 5G access point to the proximate wireless-enabled interactive programmable device. The methodology then returns to decision block 200.

The order of execution or performance of the methods and data flows illustrated and described herein is not essential, unless otherwise specified. That is, elements of the methods and data flows may be performed in any order, unless otherwise specified, and that the methods may include more or less elements than those disclosed herein. For example, it is contemplated that executing or performing a particular element before, contemporaneously with, or after another element are all possible sequences of execution.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A set-top box comprising:
a housing securing a signal input, a signal output, a processor, memory, storage, and network interface therein;
a busing architecture communicatively interconnecting the signal input, the signal output, the processor, the memory, the storage, and the network interface;
a first wireless transceiver associated with the housing and coupled to the busing architecture, the first wireless transceivers configured to communicate with a proximate wireless-enabled interactive programmable device;
a second wireless transceiver associated with the housing and coupled to the busing architecture, the second wireless transceiver configured to communicate with the proximate wireless-enabled interactive programmable device, the second wireless transceiver utilizing a fifth generation wireless signal standard;
the network interface providing a transmission link with a network;
the signal input configured to receive a source signal from an external source;
the signal output configured to forward a fully tuned signal to a display; and
the memory accessible to the processor, the memory including processor-executable instructions that, when executed, cause the processor to:
specify a search operation to identify the proximate wireless-enabled interactive programmable device, wherein the search operation utilizes one or more of the first wireless transceiver and second wireless transceiver to wirelessly identify the proximate wireless-enabled interactive programmable device,
responsive to identifying the proximate wireless-enabled interactive programmable device, utilize the second transceiver to send and receive wireless data, the wireless data utilizing the fifth generation wireless signal standard, and
utilize the network interface to provide a transmission link for the wireless data with the network.

2. The set-top box as recited in claim 1, wherein the first wireless transceiver and the second wireless transceiver are at least partially integrated.

3. The set-top box as recited in claim 1, wherein the fifth generation wireless signal standard further comprises millimeter wave band technology from 26 GHz to 60 GHz.

4. The set-top box as recited in claim 1, wherein the second transceiver further comprises a multiple input multiple output (MIMO) antenna.

5. The set-top box as recited in claim 1, wherein the second transceiver further comprises a low-band 5G antenna.

6. The set-top box as recited in claim 1, wherein the second transceiver further comprises a mid-band 5G antenna.

7. The set-top box as recited in claim 1, wherein the network further comprises a cellular network.

8. The set-top box as recited in claim 1, wherein the network further comprises a fifth generation cellular network.

9. The set-top box as recited in claim 1, wherein the network further comprises the Internet.

10. The set-top box as recited in claim 1, wherein the processor-executable instructions that, when executed, cause the processor to specify a search operation to identify the proximate wireless-enabled interactive programmable device utilizing near field communications.

11. The set-top box as recited in claim 1, wherein the processor-executable instructions that, when executed, cause the processor to specify a search operation to identify the proximate wireless-enabled interactive programmable device utilizing Bluetooth low energy data exchange.

12. The set-top box as recited in claim 1, wherein the housing further comprises a housing-dongle combination securing the signal input, the signal output, the processor, memory, storage, the first wireless transceiver, and the second wireless transceiver therewith.

13. The set-top box as recited in claim 1, wherein the second wireless transceiver is distributed through the housing-dongle combination.

14. The set-top box as recited in claim 1, wherein the processor and the memory are distributed through the housing-dongle combination.

15. The set-top box as recited in claim 1, wherein the first wireless transceiver is configured to communicate with the proximate wireless-enable interactive programmable device via a standard selected from the group consisting of infrared (IR), 802.11, 3G, 4G, Edge, Wi-Fi, ZigBee, near field communications (NFC), Bluetooth, and Bluetooth low energy.

16. The set-top box as recited in claim 1, wherein the first wireless transceiver is configured to communicate with the proximate wireless-enabled interactive programmable device via a short distance data exchange standard.

17. The set-top box as recited in claim 1, wherein the proximate wireless-enabled interactive programmable device comprises a device selected from the group consisting of personal computers, laptops, tablet computers, smart phones, smart speakers, and smart watches.

18. The set-top box as recited in claim 1, wherein the display further comprises a device selected from the group consisting of electronic visual display devices and televisions.

19. A set-top box comprising:
a housing securing a signal input, a signal output, a processor, memory, storage, and network interface therein;
a busing architecture communicatively interconnecting the signal input, the signal output, the processor, the memory, the storage, and the network interface;
a first wireless transceiver associated with the housing and coupled to the busing architecture, the first wireless transceivers configured to communicate with a proximate wireless-enabled interactive programmable device;
a second wireless transceiver associated with the housing and coupled to the busing architecture, the second wireless transceiver configured to communicate with the proximate wireless-enabled interactive programmable device, the second wireless transceiver utilizing a fifth generation wireless signal standard;
the network interface providing a transmission link with a network;
the signal input configured to receive a source signal from an external source;
the signal output configured to forward a fully tuned signal to a display;
an interactive program guide configured to provide continuously updated interactively navigable menus displaying broadcast scheduling for current and upcoming programming relative to the external source, the interactive program guide configured to provide interactively navigable menus displaying on-site hospitality information; and
the memory accessible to the processor, the memory including processor-executable instructions that, when executed, cause the processor to:
receive the source signal from the external source via the signal input,
forward the fully tuned signal to the display,
specify a search operation to identify the proximate wireless-enabled interactive programmable device, wherein the search operation utilizes one or more of the first wireless transceiver and second wireless transceiver to wirelessly identify the proximate wireless-enabled interactive programmable device,
responsive to identifying the proximate wireless-enabled interactive programmable device, utilize the second transceiver to send and receive wireless data, the wireless data utilizing the fifth generation wireless signal standard, and
utilize the network interface to provide a transmission link for the wireless data with the network.

20. A set-top box comprising:
a housing securing a signal input, a signal output, a processor, memory, storage, and network interface therein;
a busing architecture communicatively interconnecting the signal input, the signal output, the processor, the memory, the storage, and the network interface;
a first wireless transceiver associated with the housing and coupled to the busing architecture, the first wireless transceivers configured to communicate with a proximate wireless-enabled interactive programmable device;
a second wireless transceiver associated with the housing and coupled to the busing architecture, the second wireless transceiver configured to communicate with the proximate wireless-enabled interactive programmable device, the second wireless transceiver utilizing a fifth generation wireless signal standard, the fifth generation wireless signal standard being millimeter wave band technology from 26 GHz to 60 GHz;
the network interface providing a transmission link with a network;
the signal input configured to receive a source signal from an external source;
the signal output configured to forward a fully tuned signal to a display; and
the memory accessible to the processor, the memory including processor-executable instructions that, when executed, cause the processor to:
receive the source signal from the external source via the signal input,
forward the fully tuned signal to the display,
specify a search operation to identify the proximate wireless-enabled interactive programmable device, wherein the search operation utilizes one or more of the first wireless transceiver and second wireless transceiver to wirelessly identify the proximate wireless-enabled interactive programmable device,
responsive to identifying the proximate wireless-enabled interactive device, utilize the second transceiver to send and receive wireless data, the wireless data utilizing the fifth generation wireless signal standard, and
utilize the network interface to provide a transmission link for the wireless data with the network.
